(19) United States
(12) Patent Application Publication
(10) Pub. No.: US 2013/0262273 A1
(43) Pub. Date: Oct. 3, 2013

(54) SMARTPHONES AS PAGERS

(71) Applicant: Liang Cao, Saratoga, CA (US)

(72) Inventor: Liang Cao, Saratoga, CA (US)

(73) Assignee: eBay Inc., San Jose, CA (US)

(21) Appl. No.: 13/435,008

(22) Filed: Mar. 30, 2012

(51) Int. Cl. G06Q 30/00; G06Q 99/00

(52) U.S. Cl. 705/27.1; 705/1.1

(57) ABSTRACT

Methods for facilitating provision of a service or good are described. The method includes receiving the user's preferences, generating a list of merchants based on the preferences, receiving the user's selection of a merchant, placing the user on a waiting list, transmitting a notification to the user, and stopping further notifications.

### BACKGROUND

1. Field of the Invention

The present invention generally relates to the use of smartphones as pager systems.

2. Related Art

On-site pager systems are known and typically used in the restaurant industry to inform customers when their table is ready. A variety of problems exist for current pager systems. For example, a customer must physically be present to receive the vibrating restaurant pager and wait until the pager vibrates to receive service. Also, when a customer travels out of range of the paging transmitting signal, the customer never gets paged and loses his or her place in line. This can result in customers walking away and leaving with the pager. Some customers steal the pagers while others inadvertently leave with them after deciding among themselves that they do not want to wait for a table. Other pagers are damaged when they are dropped or otherwise mistreated by waiting customers.

Thus, it is desirable to provide methods and systems that provide improved paging systems and methods.

### SUMMARY

A user with a smartphone does not require a pager to be notified when a merchant service or good is available. A user checks in with a merchant, e.g., a restaurant, via the smartphone, and is placed on a waiting list. When the merchant service or good is ready, the merchant notifies the user through the smartphone. The user then unregisters from any further merchant notification.

In one embodiment, a user opens a mobile application, run by a service provider on a smartphone. The user inputs his or her preferences regarding a good or service, such as category and location. The user can optionally configure the service or goods request on the smartphone before arriving at the merchant's physical location. The service provider receives the user's preferences and generates a list of merchants based on the preferences. The user selects a merchant from the list, and the service provider places the user on the waiting list. When the selected merchant is ready, the service provider transmits a notification to the smartphone. The user can then unregister from any further merchant notification.

In another embodiment, a user logs in to a mobile application such as PayPal Local run by a service provider such as eBay, Inc. of San Jose, Calif., on a smartphone. The mobile application generates a list of merchants based on the location of the smartphone. The user selects a merchant from the list provided, and the service provider places the user on a waiting list. When the merchant is ready to provide a good or service, the service provider transmits a notification to the user's smartphone. The user can pay for the good or service using his or her smartphone and unregister from any further merchant notification.

These and other features and advantages of the present disclosure will be more readily apparent from the detailed description of the embodiments set forth below.

### BRIEF DESCRIPTION OF THE DRAWINGS

FIG. 1 is a block diagram of a networked system suitable for implementing the methods described herein according to an embodiment;

FIG. 2 is a flowchart showing a method of facilitating provision of a good or service according to one embodiment;

FIG. 3 is a flowchart showing a method of facilitating provision of a good or service according to another embodiment; and

FIG. 4 is a block diagram of a computer system suitable for implementing one or more components in FIG. 1 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

One or more embodiments of the present disclosure relates to improving customer management and efficiency at a restaurant using a smartphone as a pager. Smartphones are typically handheld devices that integrate personal information management or other computing capabilities with mobile telephone capabilities in the same device. Smartphones encompass adding mobile telephone functions to already capable Personal Digital Assistants (PDAs), or putting computing (“smart”) capabilities, such as PDA functions, into a mobile telephone. Examples of smartphones include the iPhone, Android, and Blackberry.

The present disclosure describes methods that facilitate fast and efficient restaurant service. In one embodiment, the methods selectively alert patrons of a restaurant about table availability in response to an activation signal addressed to a user smartphone from a merchant device. The activation signal selectively alerts a patron that the merchant is ready to provide a good or service to a patron. In one embodiment, the activation signal causes the smartphone to vibrate, which is accomplished by way of a vibration motor in the smartphone.

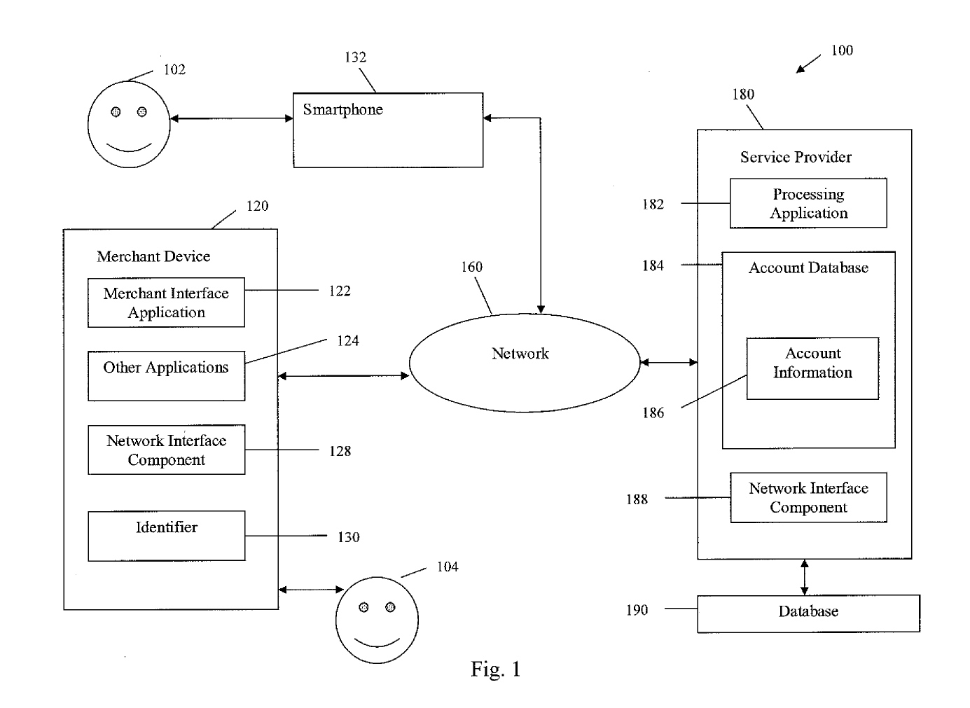

FIG. 1 shows one embodiment of a block diagram of a system 100 adapted to facilitate mobile transactions over a network 160. As shown in FIG. 1, the system 100 includes at least one merchant device 120, at least one smartphone 132, and at least one service provider server 180 in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network may comprise a wireless telecommunications network (e.g., mobile cellular phone network) adapted to communicate with other communication networks, such as the Internet.

The merchant device 120, in various embodiments, may be implemented using any appropriate combination of hardware and/or software configured for wired and/or wireless communication over the network 160. In various examples, the merchant device 120 may be implemented as a wired and/or wireless communication device (e.g., an automated user interface device) for a user 102 (e.g., a client or customer) to communicate with the network 160, such as the Internet and/or mobile network.

The merchant device 120 allows the merchant 104 to input data and information into an input component (e.g., a keyboard or keypad) of the merchant device 120 to provide information with a service request, such as the number of people in a party at a restaurant. Keypads may also be used for receiving transaction amounts or other merchant-provided inputs. It should be understood for purposes of this disclosure that keypads can include touch screens or other devices that can receive user selectable inputs.

The merchant device 120 includes one or more merchant interface applications 122, which may be used by a merchant 104 to contact the user 102 over the network 160. In one implementation, the merchant interface application 122 comprises a software program, such as a graphical user interface (GUI), executable by a processor that is configured to interface and communicate with the one or more service provider servers 180 via the network 160.

The merchant device 120, in various embodiments, may include one or more other applications 124 to provide additional features to the merchant 104. For example, these other applications 124 may include security applications for implementing client-side security features, programmatic client applications for interfacing with appropriate application programming interfaces (APIs) over the network 160 or various other types of generally known programs and/or applications.

The merchant device 120, in one embodiment, may include at least one network interface component (NIC) 128 adapted to communicate with the network 160. In various examples, the network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

The merchant device 120, in one embodiment, may include one or more identifiers 130, which may be implemented as operating system registry entries, cookies associated with the merchant interface application 122, identifiers associated with hardware of the merchant device 120, and/or various other appropriate identifiers. The identifier 130 may include attributes related to the merchant device 120, such as identification information (e.g., a system serial number, a location address, Global Positioning System (GPS) coordinates, a network identification number, etc.) and network information (e.g., network owner, network provider, network administrator, network security information, etc.). In various implementations, the identifier 130 may be passed with network traffic data and information to the service provider server 180, and the identifier 130 may be used by the service provider server 180 to associate one or more network transactions of the user 102 with one or more particular user accounts maintained by the service provider server 180.

The smartphone, 132 in one embodiment, may be utilized by the user 102 to interact with the service provider server, 180, over the network 160. For example, the user 102 may log in to a mobile application run by the service provider via the smartphone 132. In various implementations, the smartphone 132 may include at least one of a wireless cellular phone, personal digital assistant (PDA), satellite phone, etc.

In various implementations, a user profile may be created using data and information obtained from cellular phone activity over the network 160. Cellular phone activity transactions may be used by the service provider server 180 to create at least one user profile for the user 102 based on activity from the smartphone 132. The user profile may be updated with each financial and/or information transaction (e.g., payment transaction, purchase transaction, etc.) achieved through use of the smartphone 132. In various aspects, this may include the type of transaction and/or the location information from the smartphone 132. As such, the profile may be used for recognizing patterns of potential fraud, setting transaction limits on the user, etc.

The smartphone 132, in one embodiment, may include a user identifier as one or more attributes related to the user 102, such as personal information (e.g., a user name, password, photograph image, biometric id, address, social security number, phone number, email address, etc.) and banking information (e.g., banking institution, credit card issuer, user account numbers, security information, etc.). In various implementations, the user identifier may be passed with network traffic data of the user 102 to the service provider server 180, and the user identifier may be used by the service provider server 180 to associate the user 102 with a user account maintained by the service provider server 180.

In various implementations, the user 102 is able to input data and information into an input component (e.g., a keyboard) of the smartphone 132 to provide user information with a service request, such as location or type of food desired for a restaurant. The user information may include user identification information.

The service provider server 180, in various embodiments, may be maintained by an online service provider, which is adapted to transmit an activation signal on behalf of the merchant 104 to the user 102. The service provider server 180 includes at least one processing application 182, which may be adapted to interact with the merchant device 120 and the smartphone 132 via the network 160 to facilitate the provision of services and notification of the user 102. In one example, the service provider server 180 may be provided by PayPal, Inc. of San Jose, Calif., USA.

The service provider server 180, in one embodiment, may be configured to maintain a plurality of user accounts in an account database 184, each of which may include account information 186 associated with individual users, including the user 102. For example, account information 186 may include food preferences, favorite restaurants, location, etc. In another example, account information 186 may include identification information and/or private financial information of the user 102, such as account numbers, identifiers, passwords, phone numbers, credit card information, banking information, or other types of financial information. It should be appreciated that the methods and systems described herein may be modified to accommodate users that may or may not be associated with at least one existing user account.

The service provider server 180, in various embodiments, may include at least one network interface component (NIC) 188 adapted to communicate with the network 160 including the network interface component 128 of the merchant device 120 and the smartphone 132. In various implementations, the network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

The service provider server 180, in various embodiments, may include one or more databases 190 (e.g., internal and/or external databases) for storing and tracking information related to users, such as service requests and financial transactions of the user 102. For example, the databases 190 may provide a historical survey of financial transactions between the user 102 and the service provider 180. As such, in one implementation, the processing application 182 may be configured to track, log, store, and access financial transaction information and provide this information to the processing application 182 for analysis and maintenance.

The database 190 may also store, for example, address data for calling the smartphone 132. The address data may include data for communicating a text message to the smartphone 132, an e-mail address at which messages are receivable by the smartphone 132, or any other manner for communicating with the smartphone 132 so as to enable notification of the user 102 when a merchant service or good is ready. Moreover, service provider server 180 may include computer executable instructions that are operative to cause the server 180 to generate message content appropriate for messages to be communicated to the smartphone 132.

In various embodiments, the merchant device 120, the smartphone 132 and the service provider server 180 may be associated with a particular link (e.g., a link, such as a URL (Uniform Resource Locator) to an IP (Internet Protocol) address). In this regard, the user 102 may interface with the smartphone 132 via the network 160 to facilitate notification by the service provider server 180, which is discussed in greater detail herein.

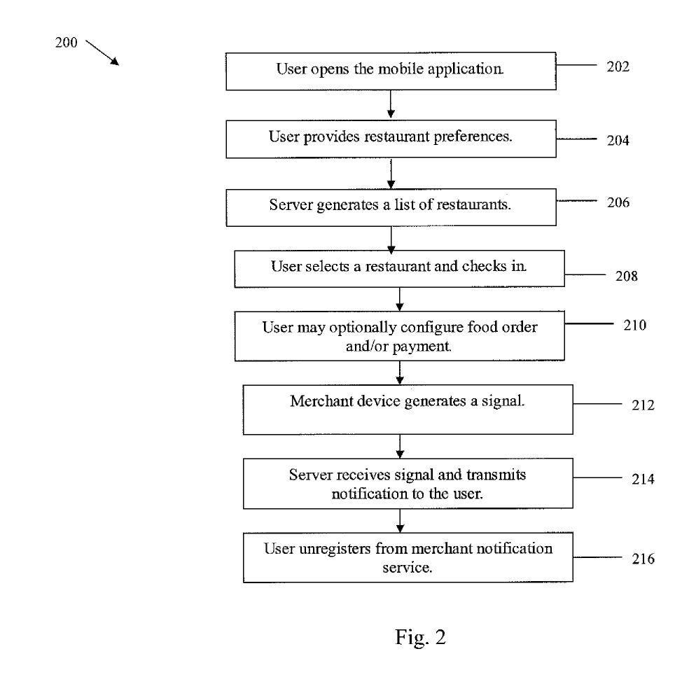

FIG. 2 is flow chart 200 showing a method of facilitating the provision of a service or good using a smartphone, according to an embodiment where the merchant is a restaurant. At step 202, the user 102 launches a mobile application on the smartphone 132. The method 200 involves the user 102 accessing a service provider site via the smartphone 132, which is adapted to communicate with the server provider server 180 via the network 160.

In one embodiment, the user 102 downloads the mobile application or “app” directly from a third party, such as an app developer site. In another embodiment, the user 102 registers with a service provider, such as eBay or PayPal, which runs the mobile application. Registration may include signing up for the service and agreeing to any terms required by the service provider, such as through a user device. In other embodiments, registration may be done completely through the user device, partially through the user device, or without using the user device, such as through a phone call or in-person visit to a representative of the service provider.

The user 102 may be requested to provider specific information for registration, such as, but not limited to, a name, address, phone number, email address, a user name for the account, and a password or PIN for the account. The type of information may depend on whether the user already has an account with the service provider. Requested information may be entered through the user device or other means, including voice or manual key entry. Once all the requested information is received and confirmed, the service provider may create an account for the user.

Once the mobile application is opened, the user 102 at step 204 selects certain criteria regarding the restaurant and seating. For example, the user 102 can select what category or kind of food is desired, e.g., Chinese, American, or Italian, specific restaurant locations, etc. The user 102 may also provide the party size, and various table preferences, such as, for example, booth or table, indoor or outdoor seating, smoking or non-smoking section, number of child seats required, etc. The mobile application enables the user 102 to find and book a restaurant table and view menus even before arriving at the restaurant. The mobile application at step 206 generates a list of restaurants based on the user's input and preferences.

At step 208, the user 102 selects a restaurant and checks in or registers with the restaurant on the smartphone 132. In one embodiment, the user 102 uses the smartphone 132 to move or slide a graphic component, such as letters, numbers, shapes, drawings, logos, or the like, on the screen of the device 132 from one location to a second location to check in to the restaurant and to enable the paging function for notification when a table is ready.

Smartphones today support quick vibrating notification via three messaging protocols including short message service (SMS), Instant Message, and Push Notification. These are common protocols that have already been adapted on iPhone, Android, and RIM BlackBerry platforms. The first two protocols may be less secure since users typically need to provide the merchant with their SMS number or Instant Message ID. The push notification protocol may be the better approach for adding such a paging function to check-in systems, such as those used in PayPal Here and Square apps.

In the present embodiment, at the time of check in, the user 102 can use an app such as PayPal 4.0 to register the push notification of a service status without providing any personal information, such as a phone number. When the service is ready for the user 102, merchant 104 can then use an app such as PayPal Here, to page the user 102 with an updated message and device vibration via his or her registered push notification. After completion of the service, the user 102 can unregister or stop any push notification automatically at the time of merchant checkout or payment.

Once the user 102 is checked in, the user 102 is entered into a waiting list of the restaurant. The user 102 can advantageously check in before the user 102 arrives at the restaurant, saving the user 102 time and increasing user satisfaction, with no waiting in line. This is achieved by accessing or launching the mobile application on the smartphone 132.

The user 102 at step 210 may optionally configure the food order and/or payment method on the mobile application before he or she arrives at the restaurant. After checking in, the user 102 may select food items to generate an order through the smartphone 132. The user 102 may also input payment information, e.g., credit card number or bank information, for the order. The food order is communicated to the local kitchen for preparation and the payment method is processed by the service provider server 180 and communicated to the restaurant. If an automatic payment is selected, the mobile application is configured to electronically process the payment and inform the restaurant that payment has already been provided.

In another embodiment, the user 102 may set up the food order and payment method upon entering the restaurant. In yet another embodiment, the user 102 may set up the payment method after the meal. The mobile application provides flexibility and gives users the option of paying their bill at any stage of the meal. In an exemplary embodiment, the user 102 pays for the meal through the PayPal Local app.

Once the user 102 is registered with the restaurant, the user 102 does not need to remain in the vicinity of the restaurant to receive notification. The user 102 is free to explore and shop in other stores in other areas.

When a table at the restaurant is ready, the restaurant informs the user 102 via the merchant device 140 by sending a signal in step 212. In one embodiment, the host or hostess presses a button on the merchant device 140 to generate a signal. The signal from the merchant device 140 is sent via the network 160 to the service provider server 180.

At step 214, the service provider server 180 receives the signal and transmits a notification to the smartphone 132 through the network 160. The service provider server 180 causes smartphone contact data to be obtained from database 190.

A notification is sent to the smartphone 132 and the smartphone 132 typically vibrates to inform the user 102 that the table is ready. The notification, however, may also be in the form of a text, phone call, email, push notification, or a combination thereof. The user 102 receives the notification and can now make his or her way back to the restaurant.

At step 216, the user 102 unregisters from the merchant notification service. As discussed above, user notification can be done via a push notification service for smartphones where the user registers for the notification service during a merchant check-in. Once the user 102 is notified that a good or service is ready, the user 102 can unregister from the service during checkout or payment so that no more notifications can be sent from the merchant 104. The user 102 registers and unregisters all via the app, such as the PayPal Local app, on the smartphone 132.

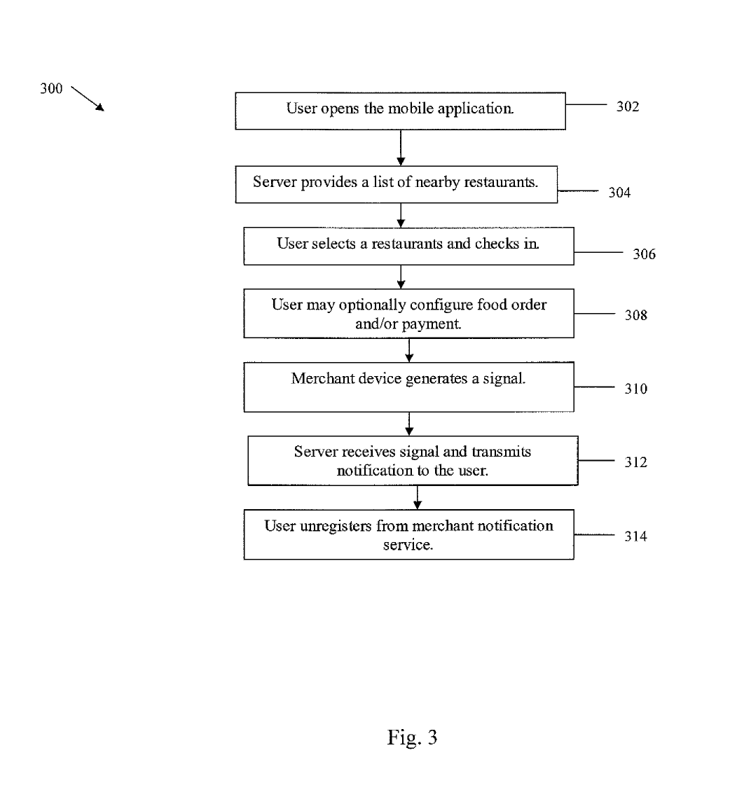

FIG. 3 is a flowchart 300 showing another embodiment of a method of facilitating the provision of a good or service using a smartphone, where the merchant is a restaurant. As in method 200, the first step 302 involves the user 102 opening the mobile application.

At step 304, the service provider server 180 informs the user 102 through the smartphone 132 which restaurants are nearby. In one embodiment, a physical location of the smartphone 132 is compared to the location of the merchant device 120 to determine if the distance between them is acceptable. The mobile application may be configured to transmit and display one or more maps showing restaurant locations, along with their respective addresses and/or phone numbers. The restaurant locations can be displayed based on a zip code entered by the user 102 or based on a GPS application that determines the closest restaurant locations relative to the location of the smartphone 132. PayPal Local is an app that helps the user 102 search for restaurants by location.

Steps 306-314 are similar to steps 208-216 of FIG. 2, and thus, the descriptions of these steps are omitted for brevity.

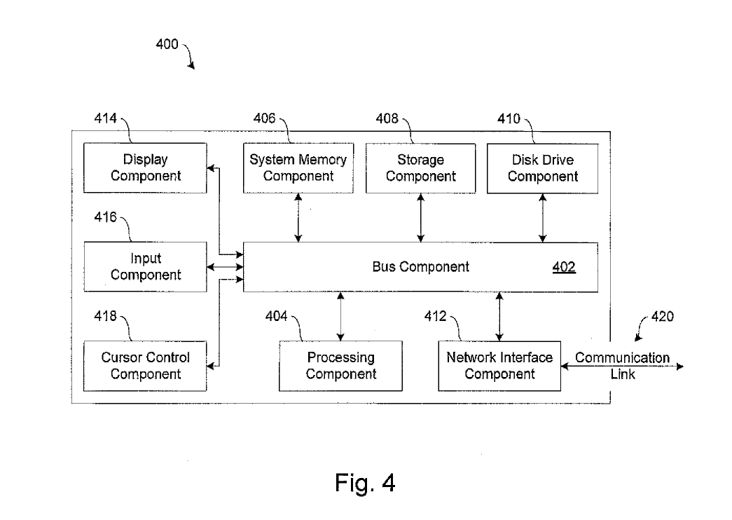

FIG. 4 is a block diagram of a computer system 400 suitable for implementing one or more embodiments of the present disclosure, including the merchant device 120, the smartphone 132, and the service provider server 180. In various implementations, the merchant device 120 may comprise a stand-alone computing device, such as an interactive computer terminal, the smartphone 132 may comprise a mobile cellular phone, personal computer (PC), laptop, PDA, etc. adapted for wireless communication, and the service processing device 180 may comprise a network computing device, such as a server. Thus, it should be appreciated that the devices 120, 132, 180 may be implemented as computer system 400 in a manner as follows.

In accordance with various embodiments of the present disclosure, computer system 400 includes a bus 402 or other communication mechanism for communicating information, which interconnects subsystems and components, such as processing component 404 (e.g., processor, micro-controller, digital signal processor (DSP), etc.), system memory component 406 (e.g., RAM), static storage component 408 (e.g., ROM), disk drive component 410 (e.g., magnetic or optical), network interface component 412 (e.g., modem or Ethernet card, such as the network interface components 128, 188 as discussed in reference to FIG. 1), display component 414 (e.g., CRT or LCD), input component 416 (e.g., keyboard), and cursor control component 418 (e.g., mouse or trackball). In one implementation, disk drive component 410 may comprise a database having one or more disk drive components.

In accordance with embodiments of the present disclosure, computer system 400 performs specific operations by processor 404 executing one or more sequences of one or more instructions contained in system memory component 404. Such instructions may be read into system memory component 406 from another computer readable medium, such as static storage component 408 or disk drive component 410. In other embodiments, hard-wired circuitry may be used in place of or in combination with software instructions to implement the present disclosure.

Logic may be encoded in a computer readable medium, which may refer to any medium that participates in providing instructions to processor 404 for execution. Such a medium may take many forms, including but not limited to, non-volatile media, volatile media, and transmission media. In various implementations, non-volatile media includes optical or magnetic disks, such as disk drive component 410, volatile media includes dynamic memory, such as system memory component 406, and transmission media includes coaxial cables, copper wire, and fiber optics, including wires that comprise bus 402. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 420 (e.g., network 160 of FIG. 1, LAN, WLAN, PTSN, or various other wired or wireless networks) may perform instruction sequences to practice the present disclosure in coordination with one another.

Computer system 400 may transmit and receive messages, data, information and instructions, including one or more programs (i.e., application code) through communication link 420 and communication interface 412. Received program-code may be executed by the processor, 404, as received and/or stored in disk drive component 410 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure.

1. A system, comprising:
a memory device storing user account information, wherein the user account information comprises smartphone contact data for a user; and
a processor operable to:
receive preferences from the user;
generate a list of merchants based on the preferences,
receive the user's selection of a merchant;
place the user on a waiting list of the merchant for a merchant service or good regardless of geographic location of the smartphone;
transmit a notification to a smartphone when the merchant service or good is available; and
stop further notifications.

2. The system of claim 1, wherein the notification is transmitted in the form of a text, vibration, phone call, email, push notification, or a combination thereof.

3. The system of claim 1, wherein the merchant is a restaurant.

4. The system of claim 3, wherein the preferences comprise type of food, location, seating arrangements, number of people, or a combination thereof.

5. The system of claim 3, wherein the processor is further operable to determine information about a user location from the smartphone and information about a location of the restaurant.

6. The system of claim 5, wherein the processor is further operable to generate a list of merchants proximate to the user.

7. The system of claim 3, wherein the processor is further operable to receive a food order and/or payment method through the smartphone.

8. The system of claim 1, wherein the processor automatically stops further notifications upon payment.

9. A non-transitory machine-readable medium comprising a plurality of machine-readable instructions which when executed by one or more processors of a server are adapted to cause the server to perform a method comprising:
receiving a user's location through a smartphone;
generating a list of merchants proximate to the user;
receiving the user's selection of a merchant;
placing the user on a waiting list of the merchant for a merchant service or good regardless of geographic location of the smartphone;
transmitting a notification to the smartphone when the merchant service or good is available; and
stopping further notifications.

10. The non-transitory machine-readable medium of claim 9, wherein the notification is transmitted in the form of a text, vibration, phone call, email, push notification, or a combination thereof.

11. The non-transitory machine-readable medium of claim 9, wherein the merchant is a restaurant.

12. The non-transitory machine-readable medium of claim 11, wherein the method further comprises receiving a food order and/or payment method through the smartphone.

13. The non-transitory machine-readable medium of claim 9, wherein stopping further notifications is automatic upon payment for the merchant service or good.

14. A method for facilitating provision of a good or service, comprising:
receiving, by a processor of a service provider, a user's preferences through a smartphone;
generating a list of merchants based on the preferences;
receiving the user's selection of a merchant;
placing the user on a waiting list of the merchant for a merchant service or good regardless of geographic location of the smartphone;
transmitting a notification to the smartphone when the merchant service or good is available; and
stopping further notifications.

15. The method of claim 14, wherein the notification is transmitted in the form of a text, vibration, phone call, email, push notification, or a combination thereof.

16. The method of claim 14, wherein the merchant is a restaurant.

17. The method of claim 16, wherein the preferences comprise type of food, location, seating arrangements, number of people, or a combination thereof.

18. The method of claim 16, further comprising determining information about a user location from the smartphone and information about a location of the restaurant.

19. The method of claim 16, further comprising receiving a food order and/or payment method through the smartphone.

20. The method of claim 14, wherein stopping further notifications is automatic upon payment for the merchant good or service.
